(19) United States
(12) Patent Application Publication
(10) Pub. No.: US 2026/0039378 A1
(43) Pub. Date: Feb. 5, 2026

(54) MULTIPLE ACCESS FOR AMBIENT IOT DEVICES

(71) Applicant: InterDigital Patent Holdings, Inc., Wilmington, DE (US)

(72) Inventors: Erdem Bala, East Meadow, NY (US); Paul Marinier, Brossard (CA); Remun Koirala, London (GB); Moon Il Lee, Melville, NY (US); Ahmed Mostafa, Ottawa (CA); Aata El Hamss, Laval (CA); Martino Freda, Laval (CA); Jongwoo Hong, New York, NY (US); Brian Martin, Farnham (GB)

(73) Assignee: InterDigital Patent Holdings, Inc., Wilmington, DE (US)

(21) Appl. No.: 18/794,673

(22) Filed: Aug. 5, 2024

(51) Int. Cl. H04B 7/22; H04W 56/00

(52) U.S. Cl. CPC H04B 7/22; H04W 56/0045

(57) ABSTRACT

Systems and methods for multiple access for ambient IoT devices or other backscatter communication based devices. A backscatter device may receive configuration information from a reader device including information indicating an identification of a timing adjustment for communicating with the reader device. The backscatter device may modulate a carrier signal transmitted by the reader device with a data signal, a timing of the modulation of the carrier signal being based on the indicated timing adjustment. The timing adjustment may include a delay of less than a period of the data signal, and may be different from a delay assigned to another backscatter device configured to modulate the carrier signal; and/or may indicate periods during which to modulate or not modulate the carrier signal, distinct from those assigned to another backscatter device.

### BACKGROUND

Some implementations of wireless devices utilize low power backscattering for communication. Such devices may be commonly referred to as ambient Internet of Things (IoT) devices, radiofrequency identification (RFID) devices, nearfield communication (NFC) devices, passive communication devices, Bluetooth Low Energy (BTLE) devices, or by similar terms (referred to generally herein as “backscatter devices”). Such devices are typically very low power (e.g. in the range of 1 microwatt to a few hundreds of microwatts) or unpowered, and may receive power from and communicate with another device (sometimes referred to as a sending device, a reader or interrogator device, an active device, or by similar terms) using backscattering. For example, a backscatter device may receive a radiofrequency (RF) signal from a sending device and may reflect the signal, after modulating it with its own data to be transmitted. The sending device may demodulate the signal to recover the data.

Backscatter devices may be very inexpensive due to their lack of power supplies or high power components, and as a result, are experiencing widespread adoption and use. For example, passive inventory tags may be attached to goods for a cost measured in cents, allowing for scanning, identification, and tracking. Backscatter communications may be adequate in one-to-one implementations in which a single sending device and single backscatter device are communicating. However, with more of these devices being utilized, particularly in close proximity, there may be congestion or interference, or an inability to communicate with multiple backscatter devices simultaneously. Distance limitations between the reader and backscatter device of a few inches may help prevent this interference, but limit the usability of the devices (e.g. inventorying all items on a store shelf without manually picking up and ‘reading’ each one). In other implementations, even limited distances may still not provide needed multi-device functionality (e.g. scanning and reading a stack of RFID cards in a user's wallet to identify a particular card, where the distance between cards may be millimeters or less).

### SUMMARY

The present disclosure is directed to implementations of systems and methods for multiple access for ambient IoT devices or other backscatter communication based devices. A backscatter device may receive configuration information from a reader device including information indicating an identification of a timing adjustment for communicating with the reader device. The backscatter device may modulate a carrier signal transmitted by the reader device with a data signal, a timing of the modulation of the carrier signal being based on the indicated timing adjustment. The timing adjustment may include a delay of less than a period of the data signal, and may be different from a delay assigned to a second backscatter device configured to modulate the carrier signal; and/or may indicate a first one or more periods of the data signal during which to modulate the carrier signal, and a second one or more periods of the data signal during which to not modulate the carrier signal. The first one or more periods and second one or more periods may be different from corresponding modulation periods assigned to a second backscatter device.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 1E is a system diagram illustrating an example backscatter device, according to an embodiment;

FIG. 2 is a signal diagram illustrating an example of backscatter communications flow, according to an embodiment;

FIG. 3 is an illustration of an example of backscatter communications, according to an embodiment;

FIG. 4 is an illustration of an example carrier wave block signal, according to an embodiment;

FIG. 5 is an illustration of modulation of an example carrier wave block signal, according to an embodiment;

FIG. 6 is an illustration of an example of mapping bits to baseband signals, according to an embodiment;

FIG. 7 is an illustration of an example of device backscatter communications utilizing cyclic shifts, according to an embodiment;

FIG. 8 is an illustration of an example timing offset between multiple backscatter communications devices;

FIG. 9A and 9B are illustrations of transmission realignment for backscatter communications, according to an embodiment;

FIG. 10 is another illustration of transmission realignment for backscatter communications, according to an embodiment;

FIG. 11 is a flow chart of a method for multiple access backscatter communications, according to an embodiment; and

FIG. 12 is a flow chart of another method for multiple access backscatter communications, according to an embodiment.

### DETAILED DESCRIPTION

The following is a non-exhaustive list of abbreviations and acronyms used herein, provided for reference purposes only. Some utilized acronyms may not appear in the following list, but may be defined in context where they appear. Additionally, some acronyms may have multiple or alternative definitions in addition to the following. One of skill in the art may readily understand their usage in context.
5GC/6GC 5G/6G Core
5GS/6GS 5G/6G System
5QI 5G QOS Identifier
AF Application Function
AMF Access and Mobility Management Function
API Application Program Interface
ARP Allocation and Retention Priority
AS Application Server
CN Core Network
DRB Data Radio Bearer
eMBB enhanced Mobile Broadband
GFBR Guaranteed Flow Bit Rate
GBR Guaranteed Bit Rate
GTP-U General Packet Radio System (GPRS) Tunnelling Protocol User Plane
HTTP Hypertext Transfer Protocol
KPI Key Performance Indicator
KVI Key Value Indicator
MCE Measurement Collection Entity
MFBR Maximum Flow Bit Rate
MOS Mean Opinion Score
MT Mobile Terminal
NAS Non-Access Stratum protocol
NEF Network Exposure Function
NF Network Function
NG Next Generation
NG-RAN Next Generation Radio Access Network
NWDAF Network Data Analytics Function
OAM Operations, Administration and Maintenance
PCC Policy and Charging Control
PCF Policy and Charging Control Function
PDB Packet Delay Budget
PDR Packet Detection Rule
PDU Protocol Data Unit
PER Packet Error Rate
QOE Quality of Experience
QoS Quality of Service
QQF QoE-Aware QoS Function
RAN Radio Access Network
RQA Reflective QoS Attribute
RRC Radio Resource Control protocol
SBA Service Base Architecture
SBI Service Based Interface
SMF Session Management Function
TCE Trace Collection Entity
UDM Unified Data Management
UDR Unified Data Repository
UP User Plane
UPF User Plane Function
URLLC Ultra Reliable and Low Latency Communication

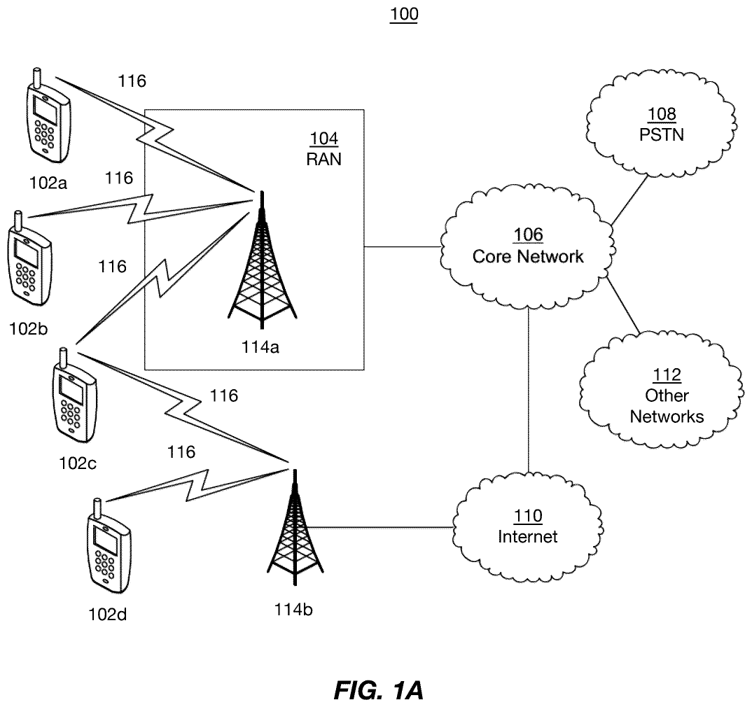

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive clement 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive clement 122 may be configured to transmit signals to, or receive signals from, a base station (e.g., the base station 114a) over the air interface 116. For example, in one embodiment, the transmit/receive clement 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. IC may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHZ channel to form a 40 MHz wide channel.

Very High Throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHZ bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. ID is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. ID may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Some implementations of wireless devices utilize low power backscattering for communication. Such devices may be commonly referred to as ambient Internet of Things (IoT) devices, radiofrequency identification (RFID) devices, nearfield communication (NFC) devices, passive communication devices, Bluetooth Low Energy (BTLE) devices, or by similar terms (referred to generally herein as “backscatter devices”). Such devices are typically very low power (e.g. in the range of 1 microwatt to a few hundreds of microwatts) or unpowered, and may receive power from and communicate with another device (sometimes referred to as a sending device, a reader or interrogator device, an active device, or by similar terms) using backscattering.

In backscattering, a device reflects a received radiofrequency (RF) signal after modulating the signal using a baseband signal. Baseband physical layer processing may use line codes for digital baseband modulation in some implementations. In a line code, digital bits may be encoded into one or a sequence of pulses. For example, bit 1 may be encoded as a pulse with voltage level +A and bit 0 may be encoded as a pulse of voltage level 0. Any appropriate voltage may be utilized—in this document A=1 is assumed without loss of generality, and other implementations may be used (e.g. A=−1, etc.). In another example, bit 1 may be encoded as a pulse with voltage level +A and bit 0 may be encoded as a pulse of voltage level −A. In yet another example, bit 1 may be encoded as a half-pulse with voltage level 0 (or −A) followed by a half-pulse with voltage level A and bit 0 may be encoded as a half-pulse with voltage level +A followed by a half-pulse with voltage level 0 (or −A). This last encoding scheme is known as Manchester encoding.

An IoT device may use backscatter modulation to transmit data to a receiver. In backscattering, a device does not generate an RF carrier but receives it from an external source and reflects the received RF signal. The baseband signal may be modulated on the reflected RF carrier. This may be achieved by using an impedance mismatch concept. An antenna impedance may be connected to a load impedance at the device. By changing the reflection coefficient (by adjusting the load impedance) over time, the amplitude, frequency, etc. of the reflected signal may be changed. For example, ON-OFF keying modulation may be achieved by using (non-reflecting state/OFF signal) or (reflecting state/ON signal). Such keying modulation may include amplitude-shift keying (ASK) or phase-shift keying (PSK) in various implementations.

For example, FIG. 1E is a system diagram illustrating an example backscatter device 150, according to an embodiment. The device 150 may comprise an antenna 142, which may be a broadband or narrowband antenna, and/or may comprise a single antenna or multiple antennas, in various implementations. The device may include an RF harvesting and power management circuit 144, which may comprise a battery, capacitor, or other energy storage device for receiving and harvesting power from a received RF signal to temporarily power other circuitry of the device. The device may further comprise a receiver 146, which may include an analog-to-digital converter (ADC), amplifier, filter, or other receiving circuitry for receiving and decoding a signal. The device may also comprise a processor 148, which may be an application specific integrated circuit (ASIC), field programmable gate array (FPGA), or any other type of hardware and/or software for executing logic to read and write data. In some implementations, processor 148 may comprise or communicate with a memory storage device (e.g. flash memory, RAM, or similar volatile and/or non-volatile memory for storing information such as a device identifier, device type, device capability, communication configuration, congestion avoidance algorithms and parameters, or other such data). The device may also comprise a transmitter 150, which may comprise a switched circuit to adjust impedance of the antenna 142 as discussed above. Such switching may be executed quickly (e.g. within a period or fraction of a period of a received carrier wave) to modulate the carrier. The modulated carrier may be reflected by the antenna 142 and received by a reader device transmitting the carrier signal (not illustrated). The reader device, sometimes referred to as an interrogator, scanner, or by similar terms, may comprise any type and form of computing device including a wireless transmit/receive unit or similar wireless communications hardware.

In some implementations, digital bits may be encoded as a sequence of pulses without using a line code. For example, bit 1 may be encoded as a square wave over a finite duration with a first periodicity and bit 0 may be encoded as a square wave over a finite duration with a second periodicity, etc. One baseband processing method that is used in some backscatter communications systems is subcarrier modulation. In this method, a subcarrier signal (that is usually a square wave) is used to multiply the line coded signal. The multiplication may be achieved by a XNOR operation (if voltage levels are unipolar) or scalar multiplication (if voltage levels are polar). The resulting signal may then be transmitted using backscatter modulation. In many implementations, except for the RF carrier signal, all signals discussed are baseband signals.

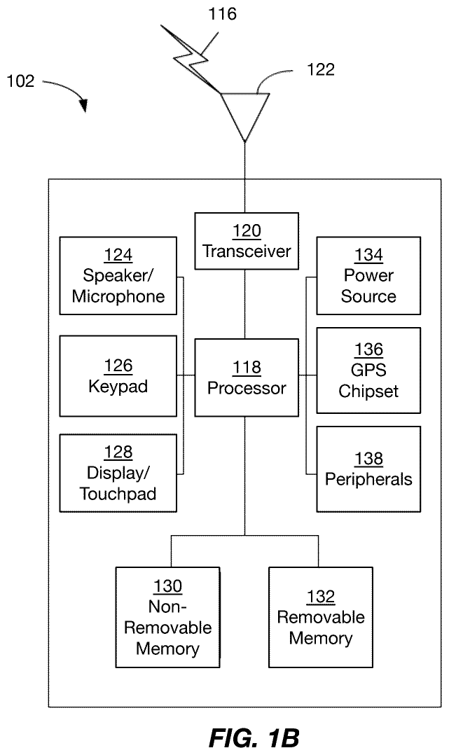

Backscatter communications may be used for asset identification (e.g. by attaching or associating a backscatter device with an asset or good, such as an item in a warehouse or store), allowing a user to scan the backscatter device with a reader device to record a unique identifier associated with the backscatter device and asset. Backscatter devices may be very inexpensive due to their lack of power supplies or high power components, and as a result, are experiencing widespread adoption and use. For example, passive inventory tags may be attached to goods for a cost measured in cents, allowing for scanning, identification, and tracking. Backscatter communications may be adequate in one-to-one implementations in which a single sending device and single backscatter device are communicating. However, with more of these devices being utilized, particularly in close proximity, there may be congestion or interference, or an inability to communicate with multiple backscatter devices simultaneously. Distance limitations between the reader and backscatter device of a few inches may help prevent this interference, but limit the usability of the devices (e.g. inventorying all items on a store shelf without manually picking up and ‘reading’ each one). In other implementations, even limited distances may still not provide needed multi-device functionality (e.g. scanning and reading a stack of RFID cards in a user's wallet to identify a particular card, where the distance between cards may be millimeters or less).

Where multiple backscatter devices are present, a congestion avoidance algorithm may be used to facilitate one-to-one communications between the backscatter device and reader. FIG. 2 is a signal diagram illustrating an example of backscatter communications flow 200, according to an embodiment. A backscatter device 202 (along with any other nearby backscatter devices, not illustrated) may receive a query 210 broadcast by a reader device 204 to energize all or a subset of devices. After receipt of the query message (and harvesting of energy), the backscatter device 202 may select a random number (e.g. from 0-2\hat{ }Q-1 in some implementations) and store the number in local memory (referred to as a counter). The reader device 204 may re-transmit the query periodically (e.g. query rep 214, 214′, 214″, 214″′, etc.). At each transmission of a query, the backscatter device 202 may decrement its counter until reaching 0 (e.g. decrement number 216, 216′). When the counter reaches 0 at 218, the backscatter device 202 may initiate a contention resolution procedure 220 comprising transmitting its device identifier (ID) or other unique identifier via backscatter modulation, and waiting for confirmation of the device ID in a subsequent acknowledgement from the reader device 204. This allows for possible collisions between multiple devices that selected the same random number. Once receiving an acknowledgement or clearing contention resolution 220, the reader device 204 can send multiple read/write commands, and the backscatter device 202 may respond via backscatter modulation.

However, this procedure still limits communications to one backscatter device and reader device simultaneously, and where large numbers of backscatter devices are present, scanning or communicating with all of them may take significant time, and/or consume significant amounts of processing and/or power resources. For example, a single warehouse or store shelf may include hundreds or even thousands of individually packaged and tagged assets-not to mention other nearby shelves or areas. Even if querying, contention resolution, and communication take only a few seconds total, this may mean minutes or hours per shelf, depending on the number of devices.

Additionally, since it is desirable for these backscatter devices to have very low complexity and consume very low power, e.g., around 1 μW or less for the simplest devices, the devices may suffer from poor sampling frequency offset (resulting in poor clocks). Furthermore, supporting higher order modulation such as M-PSK may necessitate more advanced hardware.

System spectral efficiency is determined in part by the multiple access scheme. Due to its simplicity, time-division multiple-access (TDMA) may be considered for backscatter devices. However, spectral efficiency is low and latency is high with TDMA; this is more evident when repetitions are used by the IoT device for transmission, e.g., to improve coverage.

Accordingly, implementations of the systems and methods discussed herein are directed to multiple access schemes that can support multiple devices to transmit on the same time/frequency resources. In many implementations, the multiple access schemes are robust to sampling frequency offset and simple enough to support higher order modulation.

In some implementations, a backscatter device may backscatter a carrier wave with a specific pattern (e.g., an signal generated using OFDM) after applying a transmission timing adjustment (e.g. delay) to the carrier wave. This operation may be equivalent to multiplying the carrier wave with a signal containing an OFF period followed by an ON period. The delay is used to encode a modulation symbol. Different devices encode modulation symbols on different delay values.

In brief overview, the reader device (e.g., a UE) determines a per-device mapping between a symbol (e.g., bit(s), modulation symbol) and a parameter of a signal, e.g., a signal to be backscattered. The parameter, referred to generally as a timing adjustment, may be a cyclic shift and/or delay applied to the signal before backscattering. The delay may be less than a period of the carrier wave, or may be one or more periods, discussed in more detail below. The signal may be a baseband signal. For example, bit 0 may be indicated by cyclic shift value c1 and bit 1 may be indicated by cyclic shift value c2. In many implementations, the reader device may send the mapping and/or timing information to the backscatter device or devices via one or more configuration messages.

For communications, the reader device may transmit a preamble followed by a carrier wave. For example, the preamble may contain a delimiter to indicate to the devices the start of a symbol. The carrier wave signal may be a cyclic signal. For example, the carrier wave may contain repetitions of a first signal (e.g., at least one whole and one part of the first signal).

The reader device may receive the backscattered signals (e.g., from multiple devices), and may distinguish the signals according to the cyclic shift and/or delay values (e.g., by correlating the received signal with a template corresponding to the delayed signal). The reader may decode the data symbols from the determined cyclic shift values and determine the devices transmitting the data symbols from the shift value-to-device ID mapping.

Some particular benefits of these implementations is that the backscatter device may simply apply a delay which can be implemented by an OFF period followed by an ON period of backscattering. Accordingly, it may be simple and robust to sampling frequency errors. Another benefit is that carrier wave received at the reader from the reader's own transmit antenna is orthogonal to the modulated signal received from the backscatter devices so self-interference may be easier to cancel. Still another benefit is that applying QPSK modulation may be simpler and can be performed just by applying different delay values.

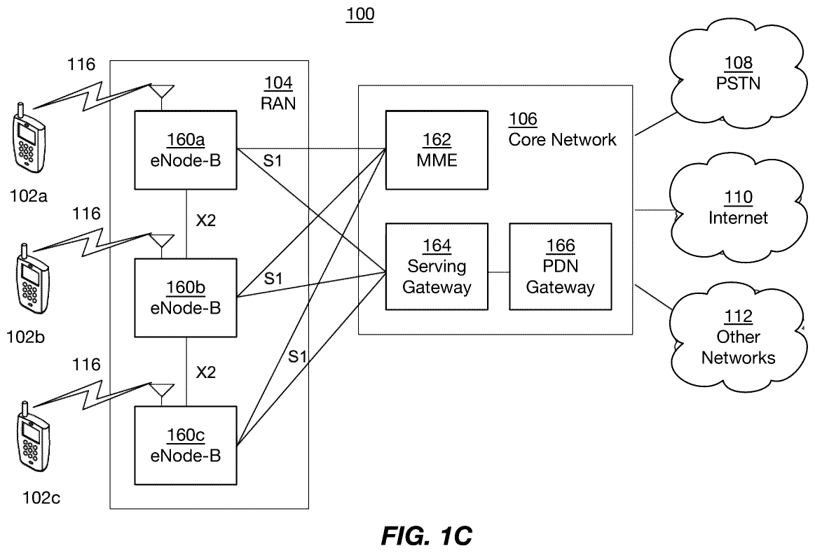

FIG. 3 is an illustration of an example of backscatter communications, according to an embodiment. Bit 0 may be encoded in a line code as a pulse of amplitude 1 followed by a pulse of amplitude 0; and bit 1 may be encoded in the line code as a pulse of amplitude 0 followed by a pulse of amplitude 1 (as discussed above, this type of line code is known as Manchester encoding, and other encodings may be utilized in various implementations). The bit (or symbol) duration is denoted as Ts. A “chip” may be defined as the smallest unit of a pulse and the amplitude of a chip is assumed to be constant over the chip duration Tc. In this figure, each Manchester symbol is composed of two chips.

The baseband line code 302 may be used to modulate a received RF sinusoidal carrier (here shown having a period of Tc/4). In this example, the amplitude of the backscattered signal 304 is changed depending on the value of the line code chip. For example, when a chip has value 1 (e.g. “on”), the received RF carrier is reflected as it is during the duration of Tc; when a chip has value 0 (e.g. “off”), the received RF carrier is absorbed, and nothing is reflected. Switching between states may be handled by a microswitch as discussed above in connection with the transmitter of FIG. 1E.

As used herein, an “inventory” procedure may refer to the overall process of a reader device triggering access by multiple backscatter devices using a sequence of messages (e.g., similar to query, followed by query rep as discussed above in connection with FIG. 2). Specifically, the inventory procedure may refer to a single round of attempts to have each device respond or attempt to respond with its access ID, or perform a Random Access Channel (RACH) procedure. For example, in some implementations, the inventory procedure refers to a set of access occasions which may have zero or one or more devices respond within the access occasion.

An access occasion may refer to the opportunity for device transmission that may be delimited by the transmission of a query rep message (or similar signal). Specifically, a backscatter device may perform transmission in an occasion by performing a backscatter transmission (sometimes referred to as an ambient IoT or In one method, the reader may indicate to a device one or more of the following:

Skip duration: indicates to the device how long to skip after the end of a transmission. The duration may be indicated (may be in term of absolute time, clock periods, and/or as a function of a measurement of another signal such as the measurement of a calibration signal. For example, the reader may send a calibration signal and the device may make a measurement on the calibration signal. The skip duration may be indicated in terms of the measured quantity. In another example, the device may send a signal (e.g., a preamble) to the reader and the reader may indicate the skip duration in terms of a quantity determined from the signal. For example, the signal may include a symbol of T as measured by the reader and the reader may indicate to the device a skip duration in terms of T.)

Transmission duration (may be in terms of absolute time, number of bits/, chips/, symbols, size of a spreading sequence). Transmission duration may be indicated with the N and k parameters where k is the number of chips/bits/symbols over which spreading is performed (this number is equal to the length of the spreading sequence) and N is the number of groups of chips/bits/symbols.

Reference point in time (may be in terms of absolute time, may be indicated with a known/predefined signal such as a preamble)

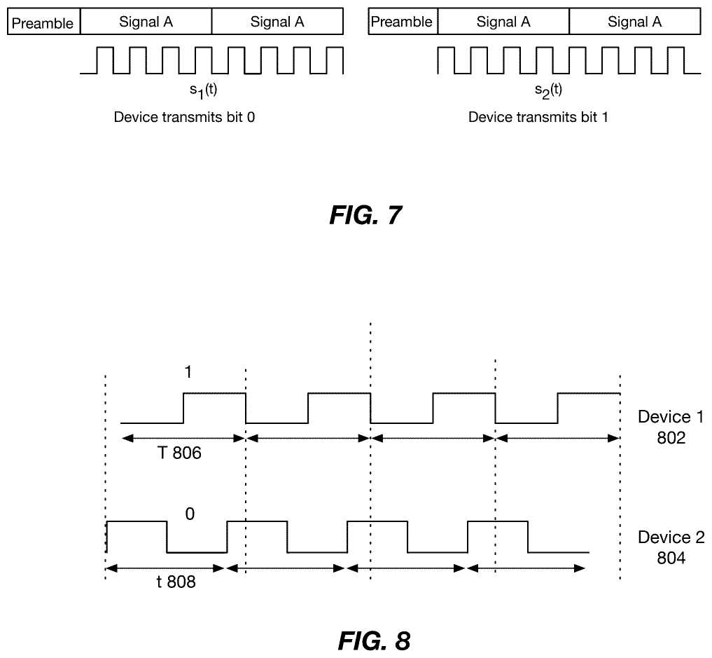

In one solution, the reader may first send a signal and/or a message (e.g., a preamble). The devices may align their initial transmission to a point in time associated and/or derived from the signal, e.g., the end of the preamble. Then, the subsequent alignments may be performed using the steps above. This method is illustrated in FIG. 9 where devices 1 and 2 align their initial transmission based on a preamble received from the reader. Subsequently, the device may skip transmission as disclosed above. Note that it may also be possible for the reader to transmit a preamble later during the transmission.

transmission) in a defined time following the query rep associated with that transmission. In other implementations, an occasion may include both a time aspect and a frequency aspect. Specifically, a backscatter device may identify an occasion as a transmission following a specific query rep, and a specified frequency (e.g., FDM). Accordingly, in various implementations, transmission occasions may refer to a time and/or frequency for performing a backscatter transmission.

As discussed above, in some implementations, a reader device may provide a configuration to one or more backscatter devices. A configuration (sometimes referred to as a pre-configuration) may refer to any configuration received via a message (e.g., an RRC message, a MAC CE, a PHY layer signal, a data PDU, a control PDU associated with any or a new protocol layer, etc.) either a network node or from another device or UE. For example, a backscatter device may be configured by a reader device, which may comprise a UE or other network node or computing device. In some implementations, the UE or reader device or other computing device may derive the device configuration itself. In other implementations, the UE or reader device or other computing device may receive a device configuration from the network, and may forward or relay the configuration from the network to the backscatter device. In some implementations, a backscatter device may generate its own configuration (e.g. via random selection of predetermined time adjustments, etc.).

As used herein, a “resource” may refer to at least any of the following: a time/frequency resource; a frequency resource which may be available at different times; and/or a time resource (possibly limited to one or more frequencies or frequency ranges) which starts from the transmission of a reader message and which lasts either a maximum period of time, or until the next transmission by the reader, possibly of a specific message.

As discussed above, in some implementations, a backscatter device may apply a timing adjustment comprising a cyclic shift on one or more of the baseband signals. For example, a backscatter device may apply a cyclic shift on the baseband signal that would be used to modulate an RF carrier. In another example, a backscatter device may apply a cyclic shift on a first baseband signal from which a second baseband signal may be derived (for example, a backscatter device may apply a cyclic shift on a baseband subcarrier modulation signal and then use this signal to modulate a baseband line encoded signal).

Applying a cyclic shift on a baseband signal may mean that a backscatter device uses a cyclically shifted version of the baseband or data signal. In similar implementations, a timing adjustment comprising a delay and/or a phase change may be applied instead of a cyclic shift or in conjunction with a cyclic shift. Applying no cyclic shift may be interpreted as applying a cyclic shift with a shift value zero. Accordingly, in various implementations, a backscatter device may receive a carrier wave (in RF) and apply a cyclic shift and/or a delay and/or a phase change on the carrier wave or data signal before backscattering (i.e. modulating the carrier wave with the data signal).

The carrier wave may comprise one or more signal blocks. For example, a signal block may comprise a signal having a finite duration, and it may be possible for a carrier wave to contain consecutive blocks. In the following, the terms carrier wave, carrier wave block, and signal block may be used interchangeably. For example, the baseband carrier wave may be generated using an OFDM modulator and the sequence used to generate the baseband carrier wave may be a Zadoff-Chu sequence. The output of an OFDM modulator (e.g., with or without a cyclic prefix) may be referred to as a block. In other implementations, the baseband carrier wave may be generated from another sequence, for example a pseudo-noise (PN) sequence. In still other implementations, the baseband carrier wave may be a single carrier signal. Accordingly, the baseband carrier wave may be simply referred to as a carrier wave or carrier signal and it may be clear from the context whether the carrier wave is in baseband or RF. For example, when carrier wave generation in the reader device is discussed, one may understand that as a baseband signal. When carrier wave reception and backscattering at a device is discussed, one may understand that as an RF signal.

In some implementations, the carrier wave may contain repetitions of a base signal and a repetition may be a full repetition or a partial repetition. For example, the base signal may be an OFDM signal generated from a sequence using an OFDM modulator. A partial repetition may be a cyclic prefix or a cyclic postfix. The carrier wave may also be padded with a certain number of zeros. Such a carrier wave may be referred to as a carrier wave block.

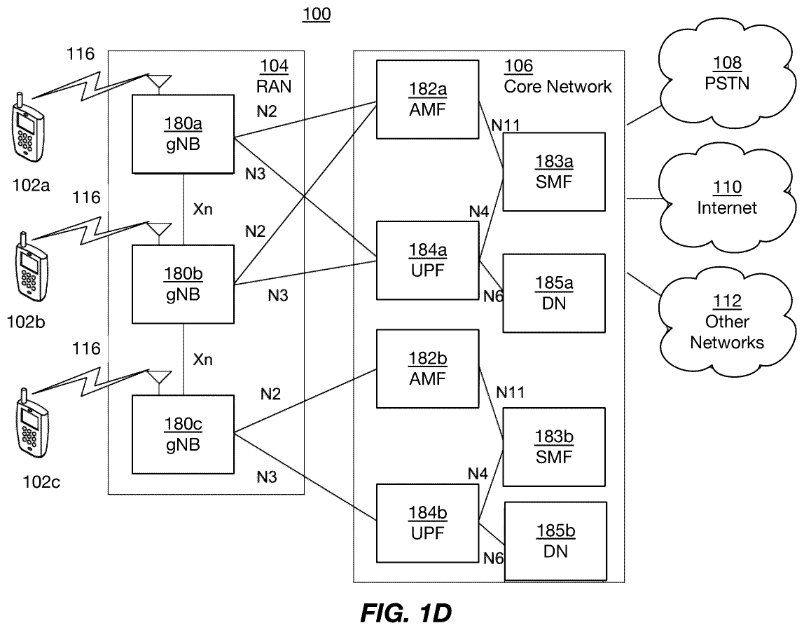

An example of a carrier wave block 400 is shown in the illustration of FIG. 4. A base signal (signal A) may be an OFDM signal (or may be other signals, in various implementations) and the example carrier wave illustrated contains four repetitions of signal A, a prefix (which may be identical to an end of a signal A in some implementations) and a postfix (which may be identical to a start of signal A in some implementations). In other implementations, a carrier wave block may not contain repetitions, for example it may just contain a base signal and possibly a prefix. The carrier wave block may also contain padding zeros.

In some implementations, a carrier wave block may be preceded with a known and/or a predefined signal, referred to variously as a delimiter, a preamble, etc. The preamble signal may indicate to a backscatter device a starting point in time of the carrier wave block 400. In some implementations, there may be a time gap between the preamble and the starting point in time of the carrier wave block (e.g. such as via a prefix). In some implementations, there may be a time gap between all or some of consecutive carrier wave blocks.

A backscatter device may backscatter the received RF carrier wave. In some implementations, the backscatter device may start backscattering as soon as the preamble is received in whole or after a specific time interval later than the preamble is received in whole (e.g. after a prefix period or other time period). The backscatter device may modulate the received RF carrier with a baseband subcarrier modulation signal before backscattering. Modulating the RF carrier may be modeled as multiplying the carrier wave with a switching signal (i.e., the subcarrier modulation signal), for example a square wave signal. The duration of the switching sequence may be the same as the duration of the carrier wave block.

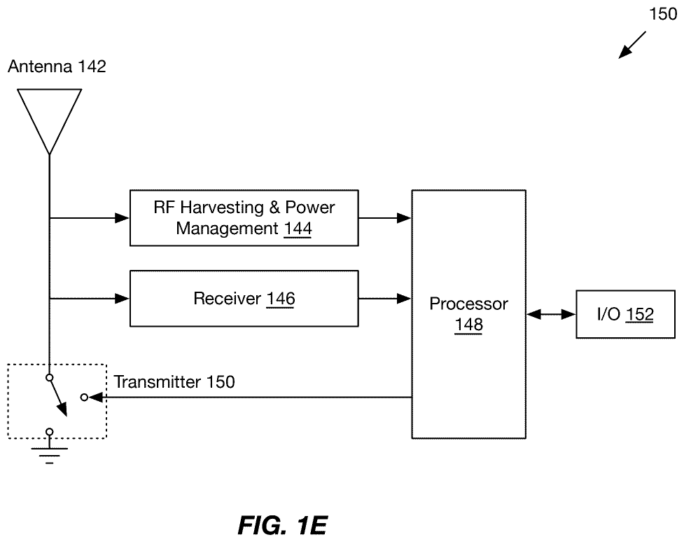

FIG. 5 is an illustration of modulation of an example carrier wave block signal, according to an embodiment. In the example of FIG. 5, a carrier wave block 502 is multiplied with a signal s1(t), referred to as a switching signal or subcarrier modulation signal 504. The voltage levels of s1(t) may be 1 and 0 in some implementations. In many implementations, the signals may not be explicitly multiplied-that is, multiplying the carrier wave block 502 with a switching signal 504 may be considered for analysis and it may not be used in implementation; rather, as discussed above in connection with FIG. 1E, an impedance load may be connected and disconnected from a transceiver of the backscatter device according to the switching signal.

The subcarrier modulation signal shows how backscattering switching may be performed at the backscatter device. For example, in on-off-keying (OOK) backscatter modulation, during the time intervals when s1(t) is 1, the received carrier wave may be backscattered as it is (since the carrier wave signal in those intervals is multiplied by 1) and during the time intervals when s1(t) is 0, no backscattering may occur, and the received carrier wave is absorbed (since the carrier wave is multiplied by 0). In another solution, the voltage levels of the subcarrier signal may be 1 and −1 (instead of 1 and 0) and in this case the carrier wave block may always be backscattered but either with the same phase (when s1(t) is 1) or with a phase difference (when s1(t) is −1). The generated signal may be referred to as a backscattered signal 506, transmitted signal, reflected signal, or by similar terms.

In some implementations, the backscatter device may apply a timing adjustment comprising a cyclic shift to the subcarrier modulation signal (i.e., the switching signal 504) and/or to the received RF carrier wave 502 and then transmit the composite signal 506 (e.g., using backscattering). For example, in some implementations, a backscatter device may determine (or reader device may provide) the value of the shift to apply in the cyclic shift procedure from at least one of the following:
A single bit. In this case, the device may determine one of two possible values based on the value of the bit;
A plurality of bits. In this case, the device may determine one of 2ⁿ possible values based on the values of a group of n bits;
A symbol; or
Random selection.

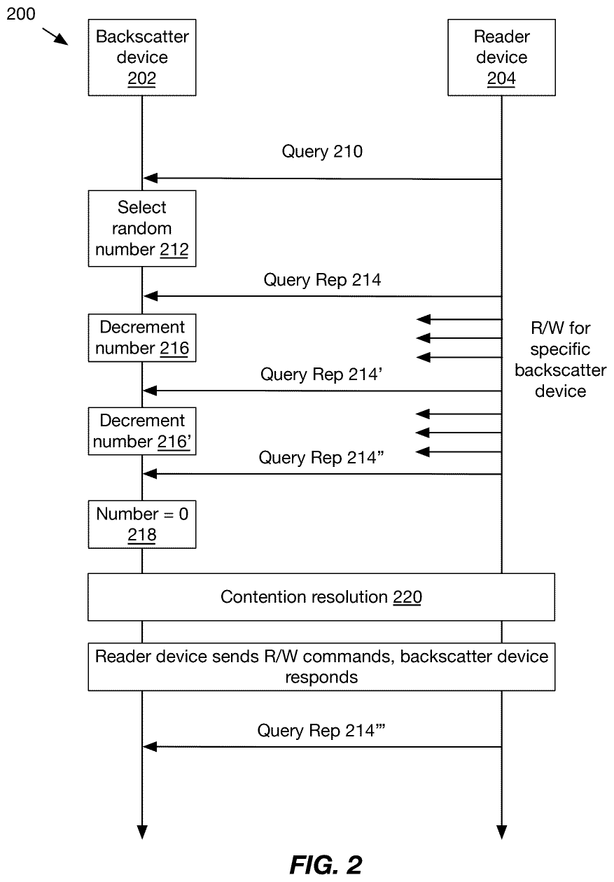

In some implementations, the backscatter device may have a mapping between a possible cyclic shift value and one or a group of bits. The backscatter device may determine a cyclic shift value from a specific bit or group of bits. The bits may be bits the backscatter device will transmit. For example, FIG. 6 is an illustration of an example of mapping bits to baseband signals, according to some implementations. In the example illustrated, to transmit bit 0 to the reader, the backscatter device may use signal s1(t) 602 as the baseband switching signal and to transmit bit 1 to the reader the device may use signal s2(t) 604 as the baseband switching signal. The signal s2(t) may be generated from s1(t) by shifting s1(t) cyclically by an amount of T/2 to the right, with T/2 equal to a chip duration T 606 being the periodicity of the square wave. In this example, s1(t) has cyclic shift value 0 and s2(t) has cyclic shift value T/2. Note that the baseband signal multiplies (and/or modulates) the received carrier wave signal and the modulated carrier wave signal is backscattered by the device.

In some implementations, a backscatter device may determine a cyclic shift value to apply to the subcarrier signal and/or the carrier wave signal (e.g., during the duration of the carrier wave block) as a function of information to be transmitted. For example, the information may be a bit or bits the backscatter device would send to the reader. For example, to transmit two bits to the reader, the backscatter device may map the two bits to one of four subcarrier signals, in which each of the four subcarrier signals may be subject to one of four cyclic shifts. In some implementations, the device may have a mapping between a cyclic shift value and one or more bits, a symbol, a codeword, etc. The mapping between a cyclic shift value and the corresponding bit(s)/symbol/codeword may be configured and/or signaled (e.g., by the reader, by the network, etc.) or may be predefined.

In some implementations, more than one backscatter device may be indicated to backscatter to the reader simultaneously on the same time resources and/or on the same frequency resources. In this method, the backscatter devices may apply different cyclic shift values during the backscattering of a carrier wave block. For example, backscatter device 1 may map bits 0 and 1 to subcarrier signals s1(t) and s2(t) respectively, while backscatter device 2 may map bits 0 and 1 to sub carrier signals s3(t) and s4(t) respectively. In many implementations, each of the subcarrier signals may contain a different cyclic shift (e.g., cyclic shift value 0, T/4, 2T/4, 3T/4), such that the modulated backscatter signals from different backscatter devices are not time-aligned. For example, the time adjustment or cyclic shift values may be non-integer multiples of the carrier wave or data signal periods, or of a chip or bit period Tc or Ts. The reader may be able to separate the transmission from different backscatter devices using the difference in the cyclic shift values the backscatter devices use for transmission.

In some implementations, a reader device may generate a configuration for a backscatter device or devices, or may receive a configuration from a network device (e.g. from a in a DCI, MAC CE, RRC message, etc.). The configuration may be based on or specify one or more of the following:
a number of devices allowed to transmit on the same time and/or frequency resources;
a maximum number of devices allowed to transmit on the same time and/or frequency resources;
a number of devices to multiplex on the same time and/or frequency resources;
a maximum number of devices to multiplex on the same time and/or frequency resources;
parameters pertaining to generation of the carrier wave. These parameters may comprise one or more of the following (but not limited to):
   the sequence to use for the generation of the carrier wave and necessary parameters for the sequence such as one or more of the following (but not limited to):
      sequence type;
      the length of the sequence;
      root of the sequence; and
      cyclic shift of the sequence;
   the duration of the base signal;
   the number of repetitions of the base signal;
   the duration of the carrier wave block;
   the subcarrier spacing used in the generation of the carrier wave;
   the RF frequency of the carrier wave;
   the size of the prefix;
   the size of the postfix;
   the number of zeros to pad;
   the transmit power of the transmitted RF carrier wave; and
   the maximum transmit power;
a mapping between values of the cyclic shift to apply by a device and bits/symbols/codewords. Note that solutions disclosed herein may assume mapping to bits but may be similarly applicable to mapping to symbols/codewords, etc.; and
a list of cyclic shift values allowed (e.g., when the scheme is used during contention-based access).

In some implementations, bits, e.g., information bits, may be encoded for transmission based on an aspect and/or feature of a transmission. One or more bits may be mapped to one of the following or a combination of more than one of the following: The bits may be uncoded information bits, bits from a group of encoded bits, bits of a codeword, etc. In some implementations, bits may be mapped to one or more cyclic shifts applied to a baseband signal and/or the RF carrier wave.

In some implementations, the backscatter device may backscatter the received carrier wave after applying a phase change on the received signal. In other implementations, the backscatter device may backscatter the received carrier wave after applying a cyclic shift on the received signal. In some implementations, the backscatter device may backscatter the received signal after modulating the received signal with a subcarrier modulation signal. The backscatter device may modulate the received signal with a subcarrier modulation signal subject to a cyclic shift. The backscatter device may modulate the received signal with a subcarrier modulation signal subject to a phase change. The backscatter device may modulate the received signal with a subcarrier modulation signal subject to a delay.

In some implementations, bits may be mapped to a cyclic shift value that may be applied to the subcarrier modulation signal, and/or the carrier wave signal. In some implementations, bits may be mapped to a phase value that may be applied to the subcarrier modulation signal, and/or the carrier wave signal. In some implementations, bits may be mapped to a delay value that may be applied to the subcarrier modulation signal, and/or the carrier wave signal. The systems and methods discussed herein may be readily utilized in either such implementations, or in a combination of such implementations. The systems and methods discussed herein may be utilized on baseband signals other than subcarrier modulation signals. Similarly, the systems and methods discussed herein may be utilized on baseband signals other than square wave baseband signals.

Similar methods may apply to a delay parameter instead of a cyclic shift value. In such contexts, a delay may refer to delaying a data signal by a certain amount of time before backscattering (i.e. modulating a carrier signal) in its entirety. In some such implementations, a cyclic shift and delay may be used together.

In some implementations, the reader may configure a separate mapping between cyclic shift values and groups of bits. The size of the group in one mapping may be different than the group size in another mapping. For example, Table 1 contains a sample mapping for a single bit and Table 2 contains a sample mapping for two bits (Ci denotes cyclic shift value with index i). Note that the cyclic shift values may be distinct between mappings to different number of bits:

TABLE 1
Mapping for BPSK

| | |
|---|---|
| 0 | C1 |
| 1 | C2 |

TABLE 2
Mapping for QPSK

| | |
|---|---|
| 00 | C1 |
| 01 | C2 |
| 10 | C3 |
| 11 | C4 |

In some implementations, the reader may indicate the mapping table index to a backscatter device (e.g., in a control message, as part of a query message, etc.). In another implementation, the reader may indicate the modulation order (i.e., how many bits to map to a cyclic shift) and a backscatter device may determine which mapping table to use.

In another implementation, the reader may indicate the mapping table index and the indices of the entries the backscatter device may use. For example, the reader may indicate to a first backscatter device to use rows 1-2 in Table 3 and to a second backscatter device to use rows 3-4 in Table 3 (in some implementations, the backscatter devices may be preconfigured with the table, or the table may be provided as discussed above):

TABLE 3

| | |
|---|---|
| 0 | C1 |
| 1 | C2 |
| 0 | C3 |
| 1 | C4 |

In some implementations, the reader may indicate to a device the modulation order and/or the indices of entries in a table of the corresponding cyclic shifts to use in the mapping. For example, using Table 4 presented below, the reader may indicate to a device to use QPSK (e.g., 2 bits per cyclic shift value) and either rows C5-C8 or C9-12:

TABLE 4

| | |
|---|---|
| 0 | C1 |
| 1 | C2 |
| 0 | C3 |
| 1 | C4 |
| 00 | C5 |
| 01 | C6 |
| 10 | C7 |
| 11 | C8 |
| 00 | C9 |
| 01 | C10 |
| 10 | C11 |
| 11 | C12 |

The reader may use efficient signaling to reduce signaling overhead. For example, to indicate the indices of entries in a table, it may indicate the index of the first entry the backscatter device may use, and the backscatter device may determine the other entries from the modulation order. In another method, for each modulation order (i.e., BPSK is 1 bit per cyclic shift, QPSK is 2 bits per cyclic shift), a number of mapping groups may be defined, and the reader may indicate the group index. For example, assuming Table 4, for BPSK, {C1, C2}, {C3, C4} may be two groups and for QPSK {C5-C8}, {C9-C12} may be two groups.

In some implementations, a backscatter device may determine the indices of entries in a mapping table based on other parameter(s), e.g., a device ID, or calculations applied to the parameters (e.g. a modulus of a device ID, or other similar functions).

In some implementations, the mapping may be predefined. The reader may send in a message the mapping and/or an aspect of the mapping. For example, bits-to-cyclic shift values may be predefined (e.g., as in a table) and the reader may configure a backscatter device with the indices of the table entries to use. In some implementations, the mapping may be sent in a first message (e.g., as in a Query) and the backscatter device specific mapping (table indices) may be sent in a second message. For example, the mapping in Table 5 may be configured in a Query message and a backscatter device may be indicated which entries to use in a subsequent message.

TABLE 5

| | | |
|---|---|---|
| 0 | C1 | Device 1 |
| 1 | C2 | Device 1 |
| 0 | C3 | Device 2 |
| 1 | C4 | Device 2 |
| 0 | C5 | Device 3 |
| 1 | C6 | Device 3 |

In some implementations, a backscatter device may randomly choose a mapping. For example, during contention-based access, a backscatter device may determine to use (C1, C2) or (C3,C4), or (C5, C6). The reader may configure the mapping and groups of mapping to use together. A backscatter device may use the group to transmit data, for example a random device ID.

The reader may also configure the number of repetitions of the base signal and/or the total duration of the carrier wave block so that the backscatter device knows when to stop backscattering.

In some implementations, a backscatter device may send signal using one of the cyclic shift values (e.g., for example using one of C1 to C6) in the table. This may happen for example in a random access. If the reader is able to detect the signal, then the reader may send a reply message and indicate the signal received successfully (e.g., by indicating the Ci index i).

In some implementations, a backscatter device may determine the value of the cyclic shift from the indicted mapping. In some implementations, the backscatter device may choose the mapping pair(s) randomly and use the same mapping until the end of data transmission, e.g., packet transmission.

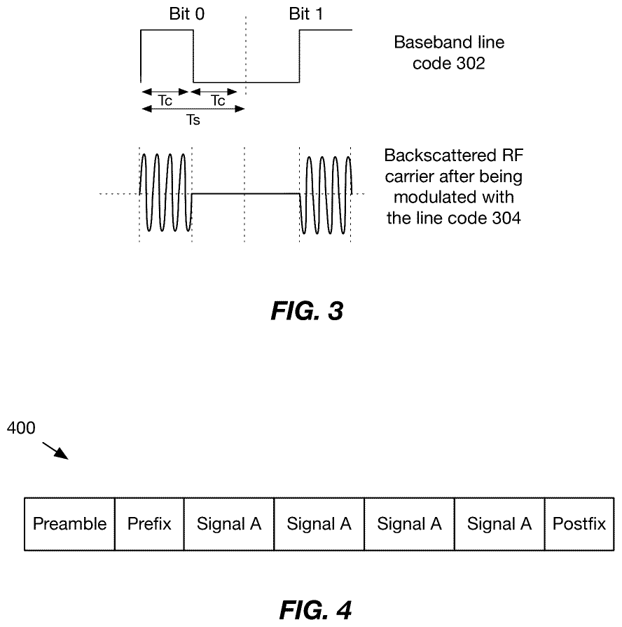

FIG. 7 is an illustration of an example of device backscatter communications utilizing cyclic shifts, according to an embodiment. As shown, the backscatter device may map bit 0 to a first baseband signal (at left) and map bit 1 to a second baseband signal (at right) in which the second baseband signal is cyclically shifted version of the first signal.

A reader may monitor the backscattered RF carrier and determine from the received signal the number of cyclic shift and/or values of the cyclic shifts applied by the backscatter devices. The reader may map the detected cyclic shift values to bits using the configured mapping.

During contention-based access, the reader may send an ACK message to the backscatter devices and in the ACK message may indicate the indices of the cyclic shifts it has detected.

Accordingly, in various implementations, multiple backscatter devices may communicate with a reader device via time-shifted backscattering during a single transmission of the reader device of a carrier wave. For example, a first backscatter device may utilize no delay, while a second backscatter device utilizes a delay of T/4; a third backscatter device utilizes a delay of T/2; a fourth backscatter device utilizes a delay of 3T/4, etc. In implementations in which the carrier frequency is multiples of the baseband or switching frequency, many different shifts or delays may be utilized.

In some implementations, backscatter devices may utilize shifts or delays larger than a period of a data signal or bit/chip/symbol period, which may be referred to as spreading. In many implementations, spreading may refer to a group of bits/chips/symbols being multiplied with or repeated according to a spreading sequence. In doing so, each bit/chip/symbol may be multiplied with or repeated according to each coefficient of the spreading sequence.

In some implementations, spreading may be applied to a bit. For example, bit sequence {1, 0} may be spread as {1 1 1 1; 0 0 0 0} if spreading sequence is [1 1 1 1] (i.e. repeating transmission of the first bit 1 four times, and repeating transmission of the second bit 0 four times). In another example, bit sequence {1, 0} may be spread as {1 1 0 0; 00 1 1} if the spreading sequence is [1 1 0 0]. Note that to get the output of the spreading operation, one may replace 0's with −1's and perform scalar multiplication; alternately, one may use an XNOR operation to compute the spreading output. Other methods may also be used.

In some implementations, spreading may be applied after line encoding and to a line code chip. For example, assume bit 1 is encoded as [0 1] using Manchester encoding. Then spreading with [1 1 1 1] gives [0 0 0 0 1 1 1 1] and spreading with [1 1 0 0] gives [0 0 1 1 1 10 0].

In some implementations, spreading may be applied per line encoded symbol. For example, symbol {0 1} becomes [0 1 0 1 0 1 0 1] if spread with [1 1 1 1] and becomes [0 1 0 1 1 0 1 0] if spread with [1 1 0 0].

In some implementations, spreading may be applied before subcarrier modulation (using any of the techniques above). Spreading may be applied after subcarrier modulation to a chip or group of chips.

Spreading may be considered a timing adjustment with a repetition or delay period equal to a multiple of a carrier period or bit/chip period. For example, given a simple spreading sequence of [0 0 0 1], the modulated signal may be considered to be delayed by three chip periods (i.e. to be transmitted in a fourth period). Similarly, with a spreading sequence of [0 0 1 1], the modulated signal may be considered to be delayed by two chip periods (i.e. to be transmitted in the third chip period) and by three chip periods (i.e. to be also transmitted in the fourth chip period). Accordingly, a timing adjustment configured for a backscatter device may interchangeably refer to a cyclic shift or delay and/or a spreading sequence of delays. In some implementations, both cyclic shifts and spreading may be utilized.

In some implementations, one or more of the following may be configured by reader and/or provided by the network to the reader:
types of spreading or what signal to which spreading should be applied to. For example, spreading may be applied to bits, chips in a baseband signal, symbols in a baseband signal, etc.;
spreading sequences; and/or
the number or the maximum number of backscatter devices applying spreading on the same time/frequency resources.

In some implementations, the reader may indicate to a backscatter device the type of spreading and the spreading sequence.

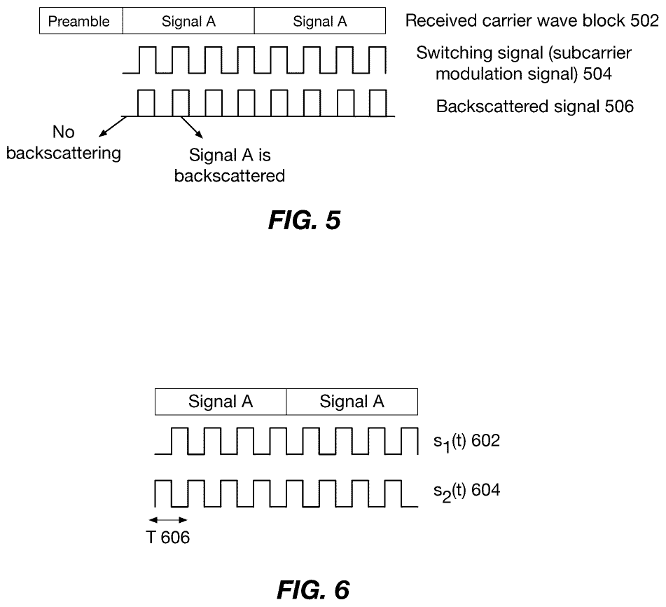

In some instances, a duration of a chip/bit/symbol from different backscatter devices may not be the same, for example due to inexpensive or low quality internal clocks of the backscatter devices. FIG. 8 is an illustration of an example timing offset between multiple backscatter communications devices. In the example shown, backscatter device 1 802 is transmitting four repetitions of bit 1 encoded using Manchester encoding and device 2 804 is transmitting four repetitions of bit 0 encoded using Manchester encoding. Note that the four repetitions may be multiplied by a multiplexing sequence (e.g., each coefficient in the sequence multiplying one Manchester symbol) and the two backscatter devices may transmit simultaneously. If the two backscatter devices have the same internal timing, the sequences would be orthogonal and readily received and distinguished by a reader device. However, in the example illustrated, the duration t 808 of each chip from device 2 804 is smaller than the corresponding chip duration T 806 of device 1 802. Due to this difference, the chips do not overlap properly, and the offset accumulates over time. As a result of this offset, orthogonality may be impacted, and the reader may not be able to separate the transmissions.

Accordingly, to address such offsets, in some implementations, a reader may align the transmissions from a plurality of backscatter devices. In some such implementations, the reader may align the beginning of transmissions (e.g., transmission of a group of chips/bits/symbols) from different backscatter devices to a reference point in time, referred to as a synchronization time, start time, or by similar terms. The group of chips/bits/symbols may be a group over which spreading is performed. In some such implementations, the reader may indicate to a backscatter device to perform alignment before and/or after every k chips/bits/symbols, where k is the number of chips/bits/symbols over which spreading is performed. In another solution, the reader may indicate to a device to perform alignment before and/or after every Nk chips/bits/symbols where N may denote a number of groups of k chips/bits/symbols.

In some implementations, in order to perform alignment, a backscatter device may be directed and/or determine to:
(a) align the starting point in time of a first transmission to a first reference point in time or synchronization time,
(b) continue transmission of the first transmission for a specific duration (the duration may be indicated or signaled by the reader, or otherwise configured);
(c) align the starting point in time of a second transmission to a second reference point in time; and
(d) skip transmission from the end of the transmission duration of the first transmission to the starting point in time of the second transmission.

FIG. 9A and 9B are illustrations of an example transmission realignment for backscatter communications, according to an embodiment. Referring first to FIG. 9A, device 2 904 may be directed to re-align its transmissions after every transmission of four symbols (e.g., the symbols may be spread with a spreading sequence of size 4). As shown, device 2 begins transmitting at a first reference point or synchronization point 906A and after transmitting four symbols (shown as blocks), may skip or pause transmitting until the start of a subsequent synchronization point 906B. Accordingly, the starting point in time of transmission of the next group of symbols is aligned to the reference time.

In some implementations, the reader may indicate to a backscatter device one or more of the following:
Skip duration: indicates to the device how long to skip after the end of a transmission. The duration may be indicated in terms of absolute time, clock periods, and/or as a function of a measurement of another signal such as the measurement of a calibration signal. For example, the reader may send a calibration signal and the backscatter device may make a measurement on the calibration signal. The skip duration may be indicated in terms of the measured quantity. In another example, the backscatter device may send a signal (e.g., a preamble) to the reader and the reader may indicate the skip duration in terms of a quantity determined from the signal. For example, the signal may include a symbol of T as measured by the reader and the reader may indicate to the device a skip duration in terms of T.
Transmission duration, which may be indicated in terms of an absolute time, number of bits/chips/symbols, and/or size of a spreading sequence. A transmission duration may be indicated with the N and k parameters discussed above, in which k is the number of chips/bits/symbols over which spreading is performed (this number is equal to the length of the spreading sequence) and N is the number of groups of chips/bits/symbols.
Reference point in time, which may be indicated in terms of an absolute time, or with a known/predefined signal such as a preamble.

In some implementations, the reader may first send a signal and/or a message indicating a beginning of a transmission period, such as a preamble. The backscatter devices may align their initial transmissions to a point in time associated with and/or derived from the signal, e.g., the end of the preamble, after a predetermined period (e.g. 1 millisecond), or after a prefix or other code block. Subsequent alignments may be performed using the steps above.

An example of this implementation is illustrated FIG. 9B, in which backscatter device 1 902 and backscatter device 2 904 each align their initial transmission to a first synchronization time 906A based on a preamble received from the reader. Subsequently, device 2 904 may skip transmitting after completing transmission of group of four bits/chips/symbols and may realign transmissions at synchronization times 906B, 906C, as described above. Note that it may also be possible for the reader to transmit or retransmit a preamble later during the transmission of the carrier wave blocks.

In some implementations, the reader may receive a preamble from a backscatter device (e.g. as part of a query response). From the preamble, the reader may estimate the backscatter device's sampling frequency offset and/or clock offset. The reader may indicate to the backscatter device one or more of the following:
The reader may indicate to the backscatter device a new duration (e.g., a chip/symbol duration) by using a control message and/or a calibration signal. Upon receiving this indication, in some implementations, the backscatter device may change the duration to the indicated duration (e.g. adjusting an internal clock rate);
The reader may indicate to the backscatter device a delta duration (e.g., a chip/symbol). Upon receiving this indication, the backscatter device may add and/or subtract the indicated duration from the actual duration; and/or.
The reader may indicate to the device whether to perform alignment skipping.

The indicated quantities may be in terms of absolute time, chips, symbols, and/or a function of a measurement of another signal such as the measurement of a calibration signal.

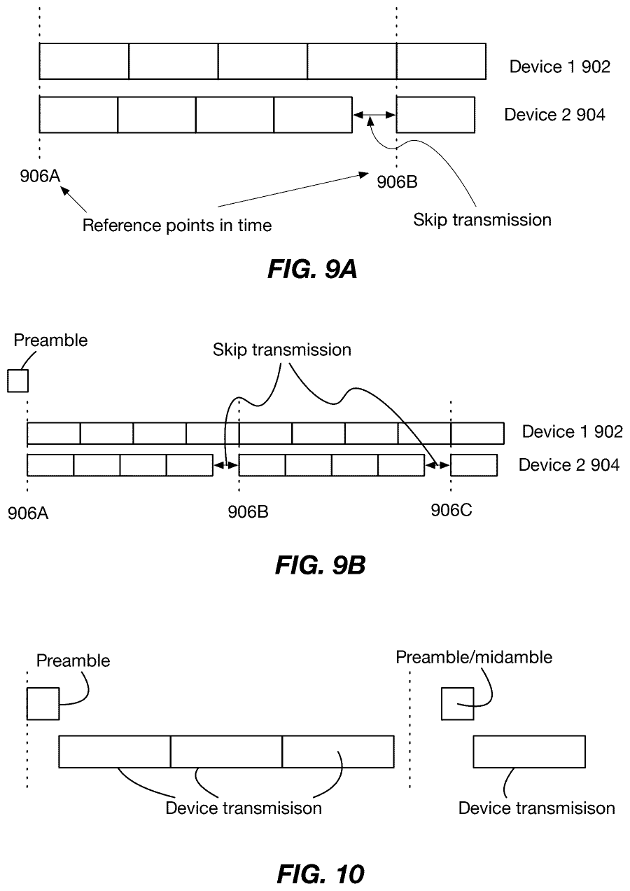

In some implementations, a reader may align the transmission from a backscatter device without using predefined synchronization times by transmitting a known signal such as a preamble or midamble. An example of such an implementation is shown in FIG. 10. In such implementations, a reader device transmits an initial preamble, and a backscatter device (e.g., a device indicated to perform alignment skipping) starts transmission (e.g., as soon as preamble is detected or after a duration from the end of the preamble). The backscatter device continues transmission for a first duration (e.g. specified in a configuration), and stops transmission after the first duration ends and begins monitoring the received carrier for an encoded preamble or midamble. Upon detection of the preamble or midamble, the backscatter device starts transmission (or resumes prior transmission if not complete) after aligning to the preamble or midamble. Such implementations may avoid relying on a backscatter device's internal clock for accuracy of synchronization times.

Accordingly, in some implementations, a reader device (e.g., a UE) determines a per-backscatter device mapping between a symbol (e.g., bit(s), modulation symbol) and a parameter of a signal, e.g., a signal to be backscattered. The parameter may comprise a timing adjustment, such as a cyclic shift and/or delay applied to the signal (or sequence of delays applied to repetitions of the signal, as in spreading) before backscattering. The signal may be a baseband signal. For example, in some implementations, bit 0 may be indicated by a cyclic shift value c1 and bit 1 may be indicated by cyclic shift value c2. In some implementations, the reader sends the mapping information to the backscatter devices in one or more configuration messages.

After providing the mapping or configuration information, the reader device (e.g., a UE) may transmit a preamble and a carrier wave. For example, the preamble may contain a delimiter to indicate to the devices start of a symbol. The carrier wave signal may be a cyclic signal. For example, the carrier wave may contain repetitions of a first signal (e.g., at least one whole and one part of the first signal).

The reader device may receive the backscattered signals from one or more devices. The reader device may determine the cyclic shift and/or delay values from the received signal (e.g., by correlating the received signal with a template corresponding to delayed signal). The reader device may determine the data symbols from the determined cyclic shift values and determine the devices transmitting the data symbols from the shift value-to-device ID mapping.

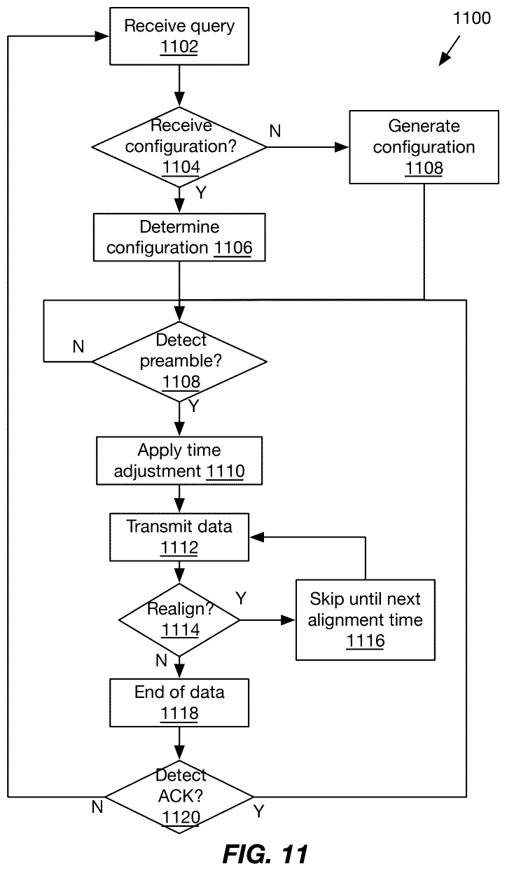

FIG. 11 is a flow chart of a method 1100 for multiple access backscatter communications, according to an embodiment. At 1102, a backscatter device, such as an inventory tag, NFC device, BTLE device, IoT device, or other such device, may receive a query transmitted by a reader device. The query may be transmitted after an identification or handshaking procedure, as discussed above in connection with FIG. 2. For example, a reader device may broadcast a first query, and a backscatter device may respond (with or without performing a congestion avoidance mechanism, as discussed above) with a device identifier and/or additional information (e.g. by modulating and backscattering a carrier signal of the first query). The reader device may then respond with a second query directed to the backscatter device at 1102.

At 1104, in some implementations, the backscatter device may determine whether the query comprises an identification of a configuration. The configuration may comprise an identification of a timing adjustment for communicating with the reader device, such as a cyclic delay or shift; a spreading sequence, length, root, and/or shift; and/or synchronization timing information. In some implementations, the configuration may also include one or more of the following: a number of devices allowed to transmit on the same time and/or frequency resources; a maximum number of devices allowed to transmit on the same time and/or frequency resources; a number of devices to multiplex on the same time and/or frequency resources; a maximum number of devices to multiplex on the same time and/or frequency resources; parameters pertaining to generation of the carrier wave including the sequence to use for the generation of the carrier wave and necessary parameters for the sequence such as a sequence type, the length of the sequence, root of the sequence, and/or cyclic shift of the sequence, the duration of the base signal, the number of repetitions of the base signal, the duration of the carrier wave block, the subcarrier spacing used in the generation of the carrier wave, the RF frequency of the carrier wave, the size of the prefix, the size of the postfix, the number of zeros to pad, the transmit power of the transmitted RF carrier wave, and/or the maximum transmit power; a mapping between values of the cyclic shift to apply by a device and bits/symbols/codewords; and/or a list of cyclic shift values allowed (e.g., when the scheme is used during contention-based access). In some implementations, the timing adjustment is a delay of less than a period of the data signal. The delay may be different from a delay assigned to a second backscatter device configured to modulate the carrier signal. In some implementations, the timing adjustment indicates a first one or more periods of the data signal during which to modulate the carrier signal, and a second one or more periods of the data signal during which to not modulate the carrier signal. The first one or more periods and second one or more periods may be different from corresponding modulation periods assigned to a second backscatter device.

If a configuration has been received, in some implementations at 1106, the backscatter device may determine and set the corresponding configuration (e.g. setting timers or counters, selecting bit mapping settings, etc., as discussed above). If not, or if the configuration is not complete, at 1108, the backscatter device may generate corresponding configuration parameters (e.g. selecting random numbers for counters, selecting mappings, etc.).

At 1108, in some implementations, the backscatter device may monitor a receiver or listen for a beginning of a transmission period. Monitoring for the beginning of the transmission period may comprise listening for a preamble or other predefined starting signal transmitted by the reader device. This may be repeated until receiving a preamble or a timeout occurs, at which point method 1100 may return to 1102.

If a preamble is detected, at 1110 in some implementations, the backscatter device may apply the time adjustment. This may comprise waiting a predetermined period before modulating a carrier signal transmitted by the reader device with a data signal at 1112, the predetermined period based on the time adjustment. In some implementations, the time adjustment may indicate a fraction of a period of the carrier signal or data signal, such as a fraction of a chip time or bit time period (e.g. T/4, T/2, 3T/4, etc.). In other implementations, the time adjustment may indicate an integer multiple of the period of the carrier signal or data signal, or a spreading value (e.g. [0 0 1 1] indicating to wait two periods/chips/symbols/etc. and then transmit a data symbol or bit twice). In some implementations, combinations of sub-period cyclic shifts and multi-period spreading delays may be utilized (e.g. spread a signal with a pattern of [0 0 1 1] at a shift of T/4).

At 1114 in some implementations, the backscatter device may determine whether to realign a transmission time period. This may be indicated in the configuration received or generated at 1106-1108, and may include parameters such as a number of chips/bits/symbols to transmit prior to realignment and/or a number of groups of chips/bits/symbols to transmit prior to realignment. If realignment is indicated, then at 1116, the backscatter device may pause or delay further transmissions (i.e. not modulating the carrier signal) until a subsequent synchronization time or detection of a preamble or midamble transmitted by the reader device. In some implementations, after realignment, data transmission may continue at 1112-1116.

At 1118, the backscatter device may finish transmitting data (e.g. device identifiers and/or other information). At 1120, in some implementations, the backscatter device may monitor a receiver or listen for an acknowledgment (ACK) or negative acknowledgement (NACK) from a reader device indicating whether the data transmission was properly received or not. In some implementations, if the transmission was properly received, the method 1100 may return to 1108 to listen for a subsequent preamble and continue transmitting data. In other implementations, if no additional data is to be transmitted, the method may return to 1102 for a subsequent reading session.

If the data was not properly received (e.g. not ACKed or was NACKed), then in some implementations, the backscatter device may monitor a receiver for a subsequent query comprising a new or modified configuration at 1102 (e.g. to correct congestion or interference with another backscatter device identified by the reader device). In other implementations, the backscatter device may first repeat 1108-1120 to retry transmission in case of intermittent interference or noise.

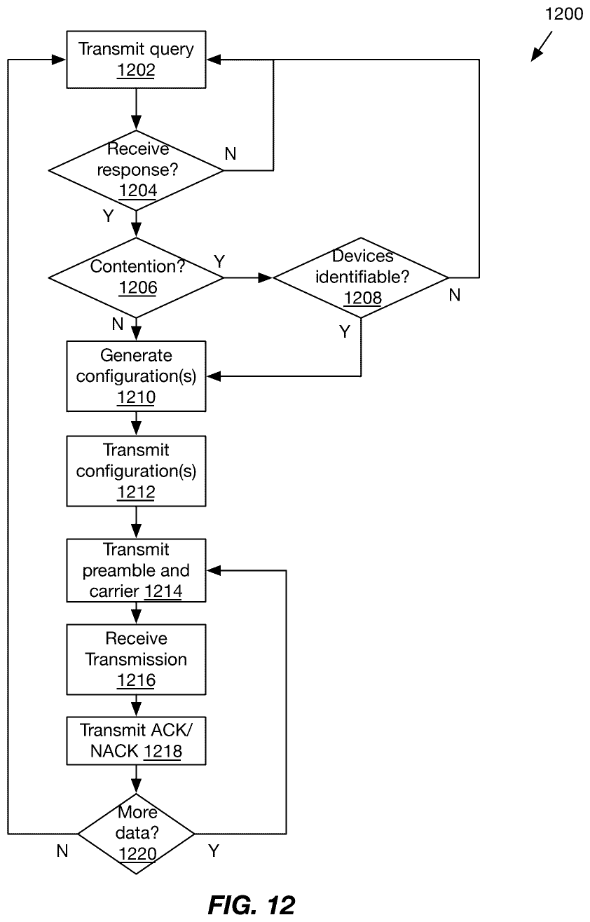

FIG. 12 is a flow chart of another method 1200 for multiple access backscatter communications, according to an embodiment. At 1202, a reader device, such as a UE, network node, or other wireless computing device, may broadcast a query comprising a carrier signal.

At 1204, the reader device may receive, from each of one or more backscatter devices, a modulated version of the carrier signal comprising an identification of the corresponding backscatter device. The identification may comprise a device identifier, asset identifier, and/or any other data. If no response is received, the reader device may repeat 1202-1204.

At 1206, in some implementations, the reader device may determine whether multiple backscatter devices have responded to the query. If so, in some implementations, the responses may be distinguishable due to timing, amplitude, frequency, modulation format, mapping, or other features. If the responses are not distinguishable and the devices are not identifiable at 1208, then the reader device may repeat 1202-1208. If the devices can be distinguished and identified, then in some implementations at 1210, the reader device may generate configuration(s) for the backscatter devices (or obtain the configurations from a network device). At 1212, the reader device may transmit the configurations to the backscatter devices. Each configuration may comprise an identification of a corresponding timing adjustment. In some implementations, the timing adjustments comprise delays of less than a period of the data signal. A delay assigned to a first backscatter device may be different from a delay assigned to a second backscatter device. In other implementations, the timing adjustments indicate a first one or more periods of the data signal during which to modulate the carrier signal, and a second one or more periods of the data signal during which to not modulate the carrier signal. The first one or more periods and second one or more periods assigned to a first backscatter device may be different from corresponding modulation periods assigned to a second backscatter device.

At 1214, the reader device may transmit, to the plurality of backscatter devices, a second carrier signal. The transmission may begin with a preamble and/or prefix in some implementations. At 1216, the reader device may receive modulated data provided based on the corresponding timing adjustments from one or more backscatter devices. In some implementations, at 1218, the reader device may transmit an acknowledgement for data successfully received (and/or a negative acknowledgement for data unsuccessfully received). At 1220, if more data is to be transmitted and/or received, then 1214-1220 may be repeated. Repeating the transmission may comprise transmitting a preamble or midamble or other indication of a synchronization time prior to a carrier signal, in some implementations. If no more data is to be transmitted or received, the method may return to 1202. In some implementations, the acknowledgement of 1218 may be transmitted after 1220 if no additional data is to be transmitted.

Accordingly, in some aspects, the present disclosure is directed to a method, comprising receiving, by a backscatter device from a reader device, configuration information including information indicating an identification of a timing adjustment for communicating with the reader device. The method also includes modulating, by the backscatter device, a carrier signal transmitted by the reader device with a data signal, a timing of the modulation of the carrier signal being based on the indicated timing adjustment.

In some implementations, the timing adjustment is a delay of less than a period of the data signal. In a further implementation, the delay is different from a delay assigned to a second backscatter device configured to modulate the carrier signal.

In some implementations, the timing adjustment indicates a first one or more periods of the data signal during which to modulate the carrier signal, and a second one or more periods of the data signal during which to not modulate the carrier signal. In a further implementation, the first one or more periods and second one or more periods are different from corresponding modulation periods assigned to a second backscatter device.

In some implementations, modulating the carrier signal further comprises repeating modulation of the carrier signal with the data signal. In some implementations, the method includes receiving, by the backscatter device, a preamble transmitted by the reader device. In some implementations, the method includes receiving, by the backscatter device, a query broadcast by the reader device comprising a second carrier signal; and modulating, by the backscatter device, the second carrier signal with an identification of the backscatter device; and the configuration information is transmitted responsive to receipt by the reader device of the modulated second carrier signal.

In some implementations, the timing adjustment identifies one or more synchronization times during transmission of the carrier signal. In a further implementation, modulating the carrier signal with the data signal further comprises: modulating the carrier signal from the beginning of the transmission period to a first intermediate time; not modulating the carrier signal from the first intermediate time to a first synchronization time; and modulating the carrier signal from the first synchronization time to a second intermediate time.

In another aspect, the present disclosure is directed to a backscatter device, comprising: a transceiver configured to receive, from a reader device, configuration information including information indicating an identification of a timing adjustment for communicating with the reader device; and a processor configured to detect a beginning of a transmission period, and modulate a carrier signal transmitted by the reader device with a data signal, a timing of the modulation of the carrier signal being based on the indicated timing adjustment.

In some implementations, the timing adjustment is a delay of less than a period of the data signal. In a further implementation, the delay is different from a delay assigned to a second backscatter device configured to modulate the carrier signal.

In some implementations, the timing adjustment indicates a first one or more periods of the data signal during which to modulate the data signal, and a second one or more periods of the carrier signal during which to not modulate the carrier signal. In a further implementation, the first one or more periods and second one or more periods are different from corresponding modulation periods assigned to a second backscatter device.

In another aspect, the present disclosure is directed to a method including broadcasting, by a reader device, a query comprising a carrier signal. The method also includes receiving, by the reader device from each of a plurality of backscatter devices, a modulated version of the carrier signal comprising an identification of the corresponding backscatter device. The method also includes providing, by the reader device, device-specific configuration information to each of the plurality of backscatter devices, each device-specific configuration information including information indicating an identification of a timing adjustment for the corresponding backscatter device. The method also includes broadcasting, by the reader device to the plurality of backscatter devices, a second carrier signal. The method also includes receiving, by the reader device from each of the plurality of backscatter devices, modulated data provided based on the corresponding timing adjustments.

In some implementations, the timing adjustments comprise delays of less than a period of a data signal of a backscatter device used to modulate the second carrier signal. In a further implementation, a delay assigned to a first backscatter device is different from a delay assigned to a second backscatter device.

In some implementations, the timing adjustments indicate a first one or more periods of a data signal of a backscatter device during which to modulate the second carrier signal, and a second one or more periods of the data signal during which to not modulate the second carrier signal. In a further implementation, the first one or more periods and second one or more periods assigned to a first backscatter device are different from corresponding modulation periods assigned to a second backscatter device.

While described primarily in terms of passive backscatter devices that receive a carrier wave or carrier signal from a reader device, the systems and methods discussed herein may be readily applied to active devices that generate or regenerate the carrier wave or carrier signal internally. For example, such a device may receive a query signal from a reader device and, rather than receiving and modulating via backscatter a carrier wave, may instead generate or regenerate the carrier wave or carrier signal internally and modulate the carrier wave with a data signal (or control a switch via a data signal to transmit or not transmit the carrier wave accordingly). Such implementations of devices may or may not include additional power supplies (e.g. batteries, capacitors, etc.), and may or may not harvest power from the signal received from the reader in various embodiments. The timing adjustments discussed herein, including cyclic shifts and spreading, may be applied similarly with internally generated or regenerated carrier waves.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method, comprising:
receiving, by a backscatter device from a reader device, configuration information including information indicating an identification of a timing adjustment for communicating with the reader device; and
modulating, by the backscatter device, a carrier signal transmitted by the reader device with a data signal, a timing of the modulation of the carrier signal being based on the indicated timing adjustment.

2. The method of claim 1, wherein the timing adjustment is a delay of less than a period of the data signal.

3. The method of claim 2, wherein the delay is different from a delay assigned to a second backscatter device configured to modulate the carrier signal.

4. The method of claim 1, wherein the timing adjustment indicates a first one or more periods of the data signal during which to modulate the carrier signal, and a second one or more periods of the carrier data during which to not modulate the carrier signal.

5. The method of claim 4, wherein the first one or more periods and second one or more periods are different from corresponding modulation periods assigned to a second backscatter device.

6. The method of claim 1, wherein modulating the carrier signal further comprises repeating modulation of the carrier signal with the data signal.

7. The method of claim 1, further comprising receiving, by the backscatter device, a preamble transmitted by the reader device.

8. The method of claim 1, further comprising:
receiving, by the backscatter device, a query broadcast by the reader device comprising a second carrier signal; and
modulating, by the backscatter device, the second carrier signal with an identification of the backscatter device; and
wherein the configuration information is transmitted responsive to receipt by the reader device of the modulated second carrier signal.

9. The method of claim 1, wherein the timing adjustment identifies one or more synchronization times during transmission of the carrier signal.

10. The method of claim 9, wherein modulating the carrier signal with the data signal further comprises:
modulating the carrier signal from the beginning of the transmission period to a first intermediate time;
not modulating the carrier signal from the first intermediate time to a first synchronization time; and
modulating the carrier signal from the first synchronization time to a second intermediate time.

11. A backscatter device, comprising:
a transceiver configured to receive, from a reader device, configuration information including information indicating an identification of a timing adjustment for communicating with the reader device; and
a processor configured to modulate a carrier signal transmitted by the reader device with a data signal, a timing of the modulation of the carrier signal being based on the indicated timing adjustment.

12. The backscatter device of claim 11, wherein the timing adjustment is a delay of less than a period of the data signal.

13. The backscatter device of claim 12, wherein the delay is different from a delay assigned to a second backscatter device configured to modulate the carrier signal.

14. The backscatter device of claim 11, wherein the timing adjustment indicates a first one or more periods of the data signal during which to modulate the carrier signal, and a second one or more periods of the data signal during which to not modulate the carrier signal.

15. The backscatter device of claim 14, wherein the first one or more periods and second one or more periods are different from corresponding modulation periods assigned to a second backscatter device.

16. A method, comprising:
broadcasting, by a reader device, a query comprising a carrier signal;
receiving, by the reader device from each of a plurality of backscatter devices, a modulated version of the carrier signal comprising an identification of the corresponding backscatter device;
providing, by the reader device, device-specific configuration information to each of the plurality of backscatter devices, each device-specific configuration information including information indicating an identification of a timing adjustment for the corresponding backscatter device;
broadcasting, by the reader device to the plurality of backscatter devices, a second carrier signal; and
receiving, by the reader device from each of the plurality of backscatter devices, modulated data provided based on the corresponding timing adjustments.

17. The method of claim 16, wherein the timing adjustments comprise delays of less than a period of a data signal of a backscatter device used to modulate the second carrier signal.

18. The method of claim 17, wherein a delay assigned to a first backscatter device is different from a delay assigned to a second backscatter device.

19. The method of claim 16, wherein the timing adjustments indicate a first one or more periods of a data signal of a backscatter device during which to modulate the second carrier signal, and a second one or more periods of the data signal during which to not modulate the second carrier signal.

20. The method of claim 19, wherein the first one or more periods and second one or more periods assigned to a first backscatter device are different from corresponding modulation periods assigned to a second backscatter device.
